(19) United States
(12) Patent Application Publication
(10) Pub. No.: US 2010/0271457 A1
(43) Pub. Date: Oct. 28, 2010

(54) Advanced Video Conference

(75) Inventor: Mukund N. Thapa, Palo Alto, CA (US)

Correspondence Address: FENWICK & WEST LLP, SILICON VALLEY CENTER, 801 CALIFORNIA STREET, MOUNTAIN VIEW, CA, 94041, US

(73) Assignee: Optical Fusion Inc., Palo Alto, CA (US)

(21) Appl. No.: 12/766,016

(22) Filed: Apr. 23, 2010

Related U.S. Application Data
(60) Provisional application No. 61/172,134, filed on Apr. 23, 2009.
(60) Provisional application No. 61/172,610, filed on Apr. 24, 2009.

(51) Int. Cl. H04N 7/15

(52) U.S. Cl. 348/14.08; 348/E07.083

(57) ABSTRACT

Methods (and corresponding systems and computer program products) providing (1) flexible controls for the number of users that register and use a system, (2) flexible group contact management control, and (3) establishing a caller's video on each receiver's screen as soon as the caller makes a video conference call.

### CROSS REFERENCE TO RELATED APPLICATIONS

This application claims the benefit of U.S. Provisional Application No. 61/172,134, “Video Conference Group Creation And The Use Of Ticket Numbers To Control Number Of Users” by Mukund N. Thapa, filed on Apr. 23, 2009, and also claims the benefit of U.S. Provisional Application No. 61/172,610, “Video Conference Incoming Call Initial Video” by Mukund N. Thapa filed on Apr. 24, 2009, and both of which are incorporated by reference herein in their entirety.

### BACKGROUND OF THE INVENTION

1. Field of the Invention

The present invention relates generally to network applications. In particular, the present invention is directed towards systems and methods for establishing video conferencing, controlling system usage, group contact management, and incoming call initial video.

2. Description of Background Art

Conventional video conferencing technologies are generally cumbersome and unnatural for users. They can also require specialized equipment or connections, thus making the video conference expensive and limiting participation only to those who have the specialized equipment and connections. For example, it is not unusual for video conferencing capabilities within a company to be based on a specialized system. The company spends a significant amount of money to purchase a limited number of specialized video conferencing equipment. This equipment is set up by the company's IT staff in specific rooms that support video conferencing. Groups who desire to have a video conference then book these rooms in advance. Details of the video conference are given to the IT staff, who make the necessary preparations in advance. At the scheduled time and only at the scheduled time, the video conference takes place, if there are no problems. If there are problems, everyone waits around until IT fixes the problem. In addition, the video conferencing service may require access to special data networks, for which the company must pay additional fees.

In addition to the above restrictions, it is desirable to control the number of users that register and use a system to allow the system to better handle the growth. It is also desirable to provide flexible group contact management control for the video conference users. It is also desirable to show a caller's video on each receiver's screen as soon as the caller makes a video conference call.

Thus, there is a need for additional video conferencing capabilities, including capabilities such as registered user number control, group contact management, and rendering initial video for incoming calls.

### BRIEF DESCRIPTION OF THE DRAWINGS

FIG. 1 is a block diagram of a server-based architecture suitable for use with the invention.

FIGS. 2A-2I are a series of screen shots illustrating a process for a user to initiate a video conference.

### DETAILED DESCRIPTION OF THE PREFERRED EMBODIMENTS

### Overview

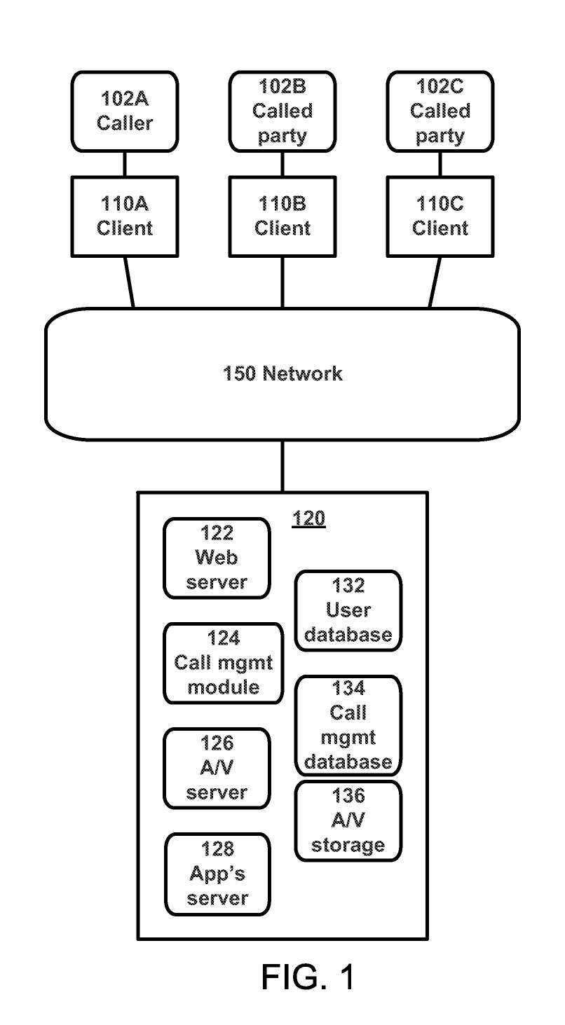

Embodiments of the present disclosure provide methods (and corresponding systems and computer program products) for (1) operating open video conferences, (2) providing registered user number control, (3) providing flexible group contact control, and (4) establishing initial video for incoming calls. The methods can be implemented through a server-based video conferencing architecture, an example of which is described in detail below with regard to FIG. 1. One skilled in the art would readily understand that the present disclosure is not restricted to this architecture, and can be implemented in other architectures such as peer-to-peer architecture.

### Architecture of a Multi-Point Multi-Person Video Conferencing System

FIG. 1 is a block diagram of a server-based video conferencing architecture for a multi-point multi-person video conferencing system suitable for use with the invention. In this example, a participant 102A desires to have a video conference with two other participants 102B,102C. For convenience, participant 102A will be referred to as the caller and participants 102B,102C as the called parties. The caller 102A initiates the video conference by making an initial video conference call to the called parties 102B,102C. The called parties 102B,102C join the video conference by accepting caller 102A's video conference call.

Each participant 102 is operating a client device 110, which connects via a network 150 to a central server 120. The network 150 may be a wired or wireless network. Examples of the network 150 include the Internet, an intranet, a WiFi network, a WiMAX network, a mobile telephone network, or a combination thereof. In this server-based architecture, the server 120 coordinates the set up and the tear down of the video conference. In this particular example, each client device 110 is a computer that runs client software with video conferencing capability. To allow full video and audio capability, each client device 110 includes a camera (for video capture), a display (for video play back), a microphone (for audio capture) and a speaker (for audio play back).

The client devices 110 are connected via the network 150 to the central server 120. In this example, the central server 120 includes a web server 122, a call management module 124, an audio/video server 126 and an applications server 128. The server 120 also includes user database 132, call management database 134 and audio/video storage 136. The participants 102 have previously registered and their records are stored in user database 132. The web server 122 handles the web interface to the client devices 110. The call management module 124 and call management database 134 manage the video conference calls, including the set up and tear down of video conferences. For example, the call management database 134 includes records of who is currently participating on which video conferences. It may also include records of who is currently logged in and available for video conference calls, their port information, and/or their video conferencing capabilities. The audio/video server 126 manages the audio streams, the video streams, and/or the text streams (collectively called media streams) for these video conferences. Streaming technologies, as well as other technologies, can be used. Storage of audio and video at the server is handled by audio/video storage 136. The application server 128 invokes other applications (not shown) as required.

### Process for Initiating a Video Conference

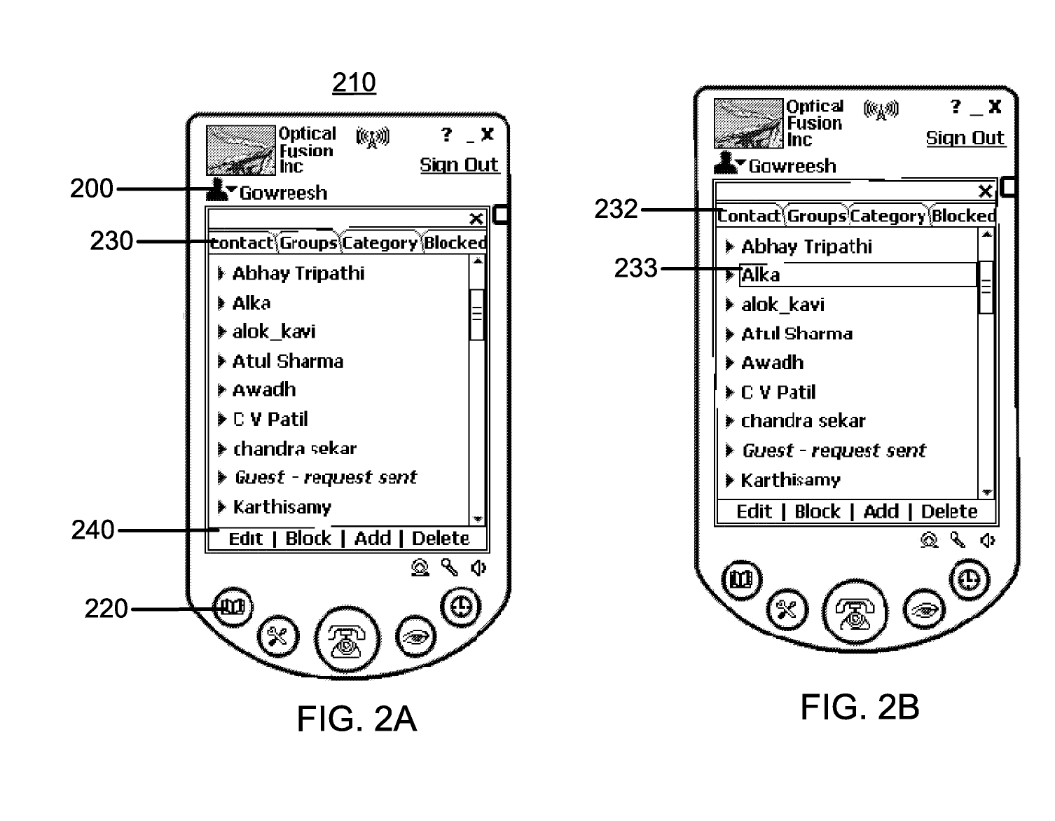

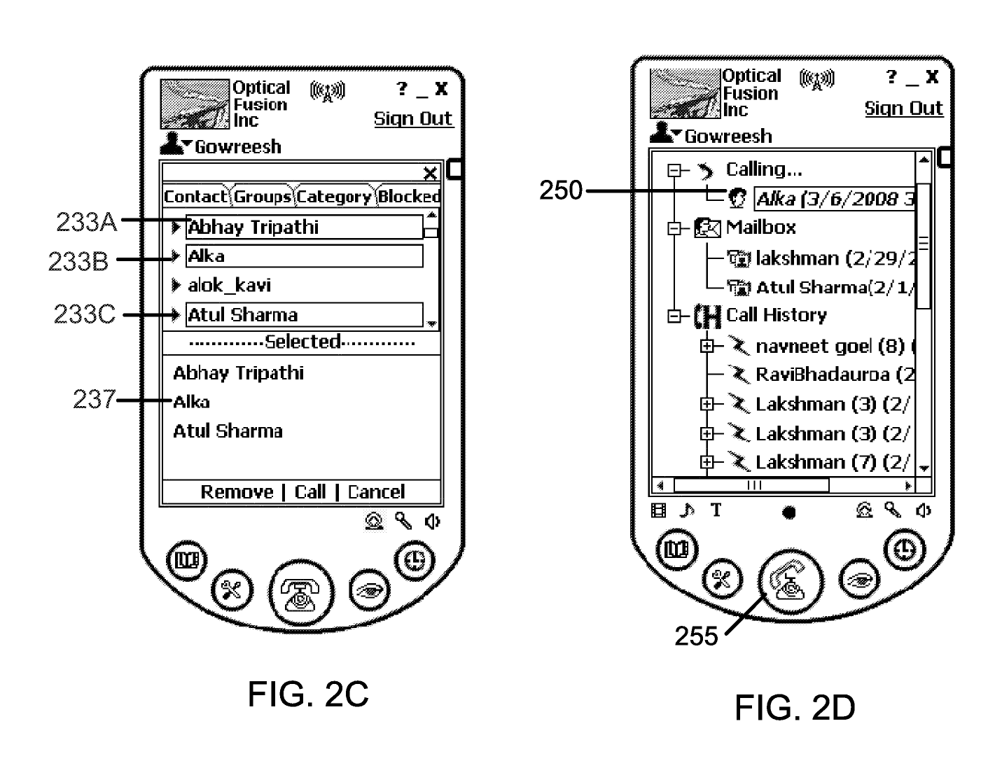

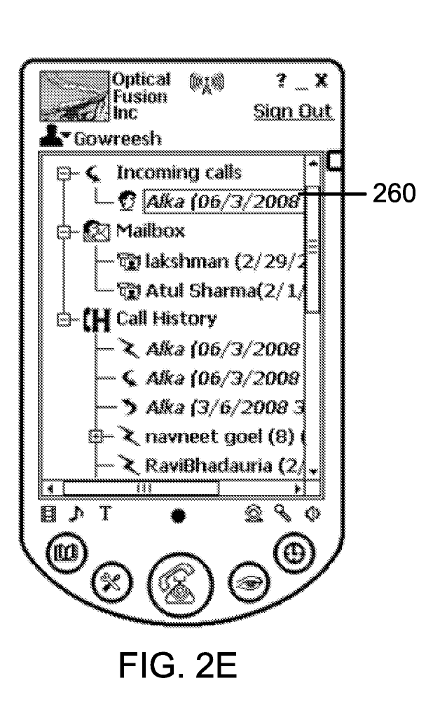

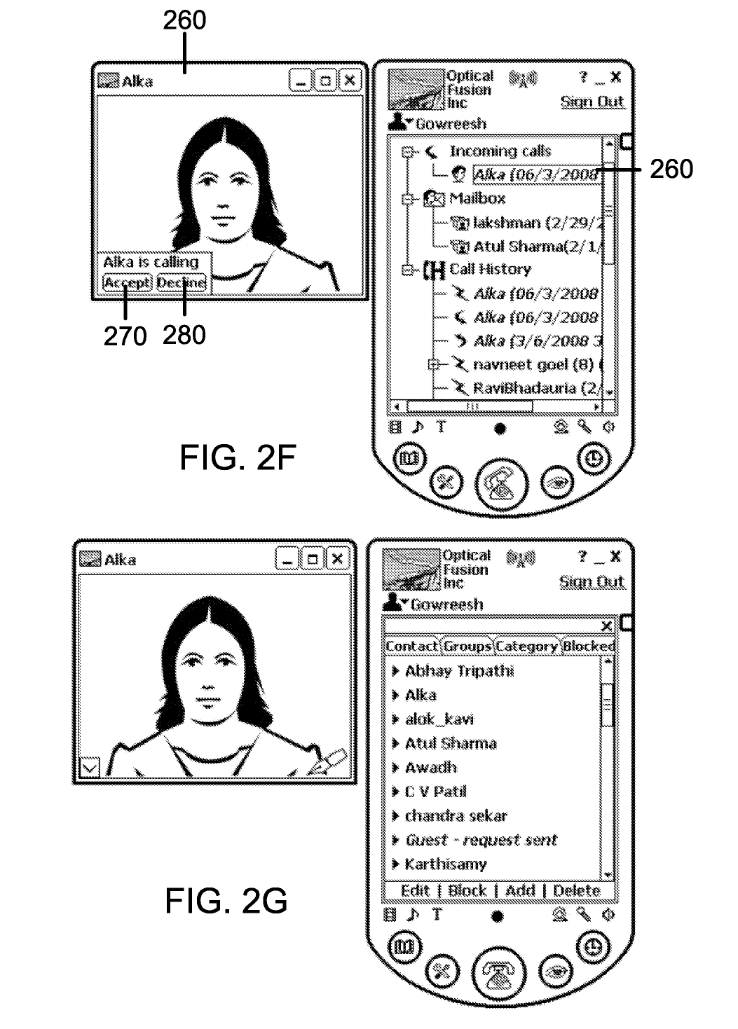

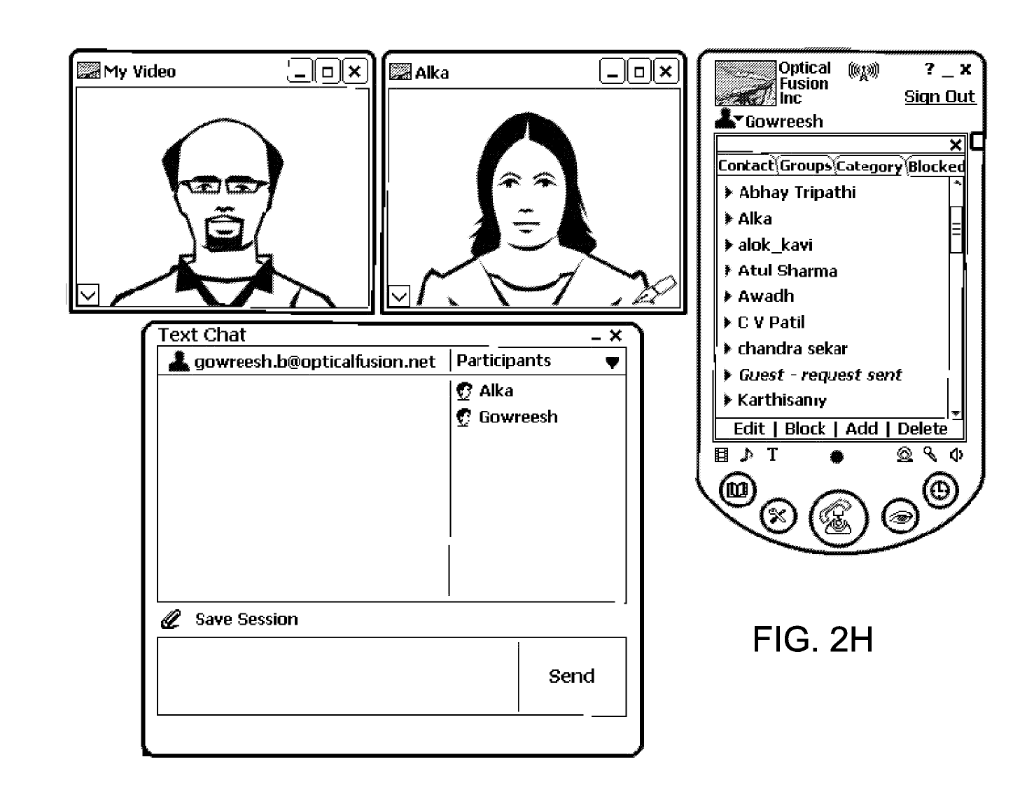

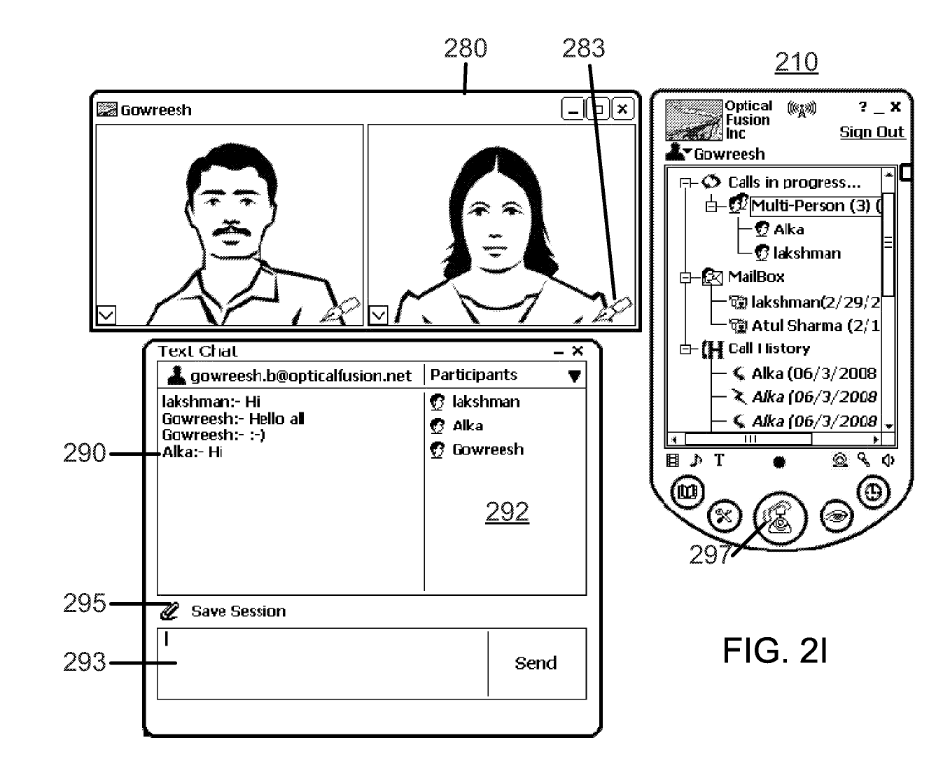

To begin the video conference initiation process, the caller 102A selects the other participants 102B,102C (also called “called parties”) for the video conference. In FIGS. 2B and 2C, the caller 102A selects the other participants 102B,102C from his address book (tab 232). In FIG. 2B, the caller 102A (Gowreesh) is selecting Alka 233, as shown by the highlighting of this contact. In FIG. 2C, the caller Gowreesh has selected multiple other participants: Abhay, Alka and Atul, as indicated by the highlighted contacts 233A,B,C. The currently selected participants are also shown in area 237. When the caller is finished selecting participants, the caller makes an initial video conference call, which sends the list of selected participants from client 110A to the server 120.

The caller 102A makes the initial video conference call by activating the call button 255, which is prominently placed due to its importance. FIG. 2D shows a screen shot where the caller's communicator 210 has an indication 250 that a video conference call is being placed to Alka. Naturally, although FIG. 2D shows a video conference call being placed only to Alka, the video conference call can be placed to more than one person at a time.

The server 120 begins to set up the video conference call by creating an entry for the new video conference in a conference table (also known as the call table) within the call management database 134. In one implementation, this entry includes a unique conference ID to identify the new video conference, possibly a conference name, a conference type (public, private, or hidden), and a conference administrative ID corresponding to the caller 102A. The server 120 also inserts the list of participant ID's into the conference entry, in this example implementation by use of a user table that includes conference ID, user ID, and A/V capability (e.g., audio, video and/or text). The server 120 obtains the IP address, login port number and session ID for participants from a table of logged in users, which may also be maintained as part of the call management database 134 (or the user database 132).

Assuming the called parties 102B,102C are logged on, the server 120 sends an initial request to their client devices 110B,110C. This could be in the form of a ring, for example. FIG. 2E shows a screen shot of a called party receiving notification 260 of an incoming video conference call. Note that, in this example, Gowreesh and Alka have changed roles. FIG. 2E still shows Gowreesh's communicator. However, Alka is the caller and Gowreesh is the called party. The communicator shows 260 that Alka is calling Gowreesh.

In FIG. 2F, the notification 260 also includes a window showing the caller. The called party can accept the video conference call and join the video conference by activating the accept button 270. Once the called party joins the video conference, the other participants 102 are made aware of his presence. At the server 120, the conference table is updated to include the participants 102 that accepted. As a result, the server 120 now routes the media streams (e.g., video, audio, and/or text) to and from the new participants 102.

FIGS. 2G-2I show screen shots of a video conference. In FIG. 2G, there is one other participant, Alka, in addition to the caller Gowreesh. FIG. 2H is an alternate interface that shows Gowreesh in addition to Alka. In FIG. 2I, a third participant Lakshman has joined the video conference. FIG. 2I shows the main communicator element 210, a video conference window 280 that shows both of the other participants, and a third window 290.

This ancillary window 290 displays a list of the current participants 102 and also provides for text chat. The participant's text chat is entered in area 293. Text chat can be shared between all participants or only between some participants (i.e., private conversations). The participant can initiate private communications or send private text messages by clicking on the pen icon. For example, Gowreesh's clicking on Alka's pen icon 283 establishes text chat between Alka and Gowreesh. In addition to text, files can also be shared by clicking on the attachment icon 295. Text chat and attachments can be saved.

Similarly, the called party can decline the video conference call by clicking the decline button 280, as shown in FIG. 2F. The corresponding client device 110 sends a notification to the server 120 reporting the declination. The server 120 updates the conference table and notifies the other participants 102 of the declination. When a called party declines the video conference call or is not logged in to the server 120, the server 120 can provide a videomail service to the caller. The caller can then leave a videomail message for the called party.

FIGS. 2A-2I illustrate one example, but the invention is not limited to these specifics. For example, the video conference can be previously scheduled by a participant 102 or a non-participating user. The server 120 initiates the scheduled video conference by sending an initial request to all scheduled participants 102 at the scheduled date and time. As another example, client devices 110 other than a computer running client software can be used. Examples include PDAs, mobile phones, web-enabled TV, and SIP phones and terminals (i.e., phone-type devices using the SIP protocol that typically have a small video screen and audio capability). In addition, not every client device 110 need have both audio and video and both input and output. Some participants 102 may participate with audio only or video only, or be able to receive but not send audio/video or vice versa. The underlying architecture also need not be server-based. It could be peer-to-peer, or a combination of server and peer-to-peer. For example, participants that share a local network may communicate with each other on a peer-to-peer basis, but communicate with other participants via a server. The underlying signaling protocol may be a proprietary protocol or a standard protocol such as Session Initiation Protocol (SIP). Other variations will be apparent.

### Using Ticket Numbers to Control Number of Users

Described below is a process for controlling the usage of a system during roll-out using ticket numbers. The process controls the total number of users in the system, and does not necessarily restrict simultaneous (or instantaneous) usage. The process can be used for any type of phased roll-out. One ticket number can be used to allow one or several users to register.

Below are characteristics of the ticket numbers:
1. A ticket number is unique and allows exactly one person to register using such a number.
2. The ticket number can be tied in with a particular email ID; thus providing a level of security. Though it is not a requirement to tie it with any specific ID.
3. Designated people can have the ability to provide ticket numbers to unlimited people.
4. These designated people can also allow others to create a fixed set of ticket numbers for other users.
5. Ticket numbers can be transferrable.
6. Ticket numbers can be provided to a user to create his/her group of contacts. In which case all those who register under this scheme will be in each other's address book. Alternatively it can be specified that they will only be in the main user's address book.

### User Experience

The front end of a ticket number management system can use a web-based form or a form that pops up from the settings section of the communicator. The administrator of the database designates certain individuals as having the ability to provide additional ticket numbers without limit. This is done by an entry on the database (e.g., a flag). These individuals will be referred to as ticket providers. When any of these individuals log in they automatically have the ability to create ticket numbers. If they log in on the website then they see an option under their account. If they log in via their communicator, then they can see the option in their settings section.

The specification of the ticket numbers is through a form with the following fields:
1. History and new ticket numbers:
   a. If previously registered, then previously specified ticket numbers, amount used, amount available, new ticket numbers.
   b. If not registered, then just ticket numbers to allocate.
2. Properties of new ticket numbers:
   a. Include everyone in authorizer's address book (and vice versa).
   b. Include person allotted ticket numbers in item 1 above in each invited person's address book.
   c. Do item (b) but also include everyone in each other's address books.

### Back-End Process

The options described above require some processing via the servers and database.
1. Authorized users who can issue unlimited ticket numbers are created by the administrator.
2. An authorized user logs in and has the option of inviting anyone as well as issuing ticket numbers per the options discussed earlier.
3. Suppose the authorized user invites Person A and issues n ticket numbers. (Note, if Person A is already a registered user then only n ticket numbers are issued. The count can be treated in many ways; i.e., not count Person A as specified here, or count Person A, in which case n-1 more can be allocated)
4. The request is sent to the server where the options are recorded.
5. An email is sent to Person A inviting him/her to register (if already registered, then this step is skipped.)
6. Once Person A registers (or is already registered), the server sends an email indicating how many ticket numbers have been assigned. (If previously registered and previously assigned ticket numbers, then an update is provided as to how many are used, how many new ticket numbers are assigned.)
7. Copies of emails are also sent to the authorized user. Email is also sent to the authorized user when Person A registers. (Emails for other registrants of Person A are not sent, though could be. Instead the authorized user can view summary reports through his/her account).
8. The registered Person A can then send out invitations by, for example, clicking the Add button in the address book portion of the communicator. Each person that Person A adds, will be provided a ticket number and allowed to register but will not be allowed to invite anyone else.
9. When the invited people register with their ticket number the following happens:
   a. Their ticket number is checked for authenticity.
   b. The options related to this are checked. Then based on these options they are added to each other's address books plus Inviter's (Person A) address book, only to the Inviter's address book, and/or to the authorized user's address book. The authorized user is the person who granted Person A the ticket numbers.

### Group Contact Management

Described below is a process that provides flexibility in inviting and creating groups. In one embodiment, the above-described usage of ticket numbers is used for controlling the number of users in an early release. After the initial early release there will be no restriction on the users. From this point on any user will be able to invite others to join and will be able to request that someone be added to his/her address book.

Groups are a set of users selected from the full list of contacts that a user has. A contact can appear in multiple groups. Further details regarding the groups and how groups can be created, modified, deleted, and used in making calls or scheduling calls can be found in U.S. Provisional Application No. 60/976,464, “Video Conference Interface & Features” by Mukund N. Thapa, filed on Sep. 30, 2007, which is incorporated by reference herein in its entirety.

Described below are processes that allow a user to invite other users into predefined groups or into a newly created group.

### User Experience

Once signed in the user can click the Add (or Invite) button on the communicator contact manager, to put another user into his/her contact book. The same procedure can also be invoked on the web through the user account. The inviter mentioned below is the user who is adding others to his address book (contact manager).

Upon clicking the Add button a form becomes available with the following fields:
1. Users to invite. Here the Inviter types in a list of User IDs and/or email addresses of the users to invite. An example of the User ID is the email address. In one embodiment, the system verifies if the Users are on the system.
2. Add users to address book, no groups. In this case a group is not specified for the invited users. This is the default option.
   a. The Inviter can choose to simply add users to his/her address book.
   b. The Inviter can also specify that all users are added to each other's address books.
3. Add users to existing groups. If this option is checked,
   a. The Inviter is asked to select from a list of groups that are available in the Inviter's address book (also referred to as the Contact Manager). Say the group selected is labeled as “Tennis.”
   b. In addition, the inviter can choose to include all the group members in each other's address books. Any existing group members will also have the new users added to their address book and new members will also have all existing members added into the group “Tennis.”
   c. If the invited users do not have a group named “Tennis”, a new group will be created called “Tennis”. If they already have a group called “Tennis”, then a new group called “Tennis2” will be created. If that exists also, then “Tennis3” and so on.
   d. The Inviter can also opt to have the group only created in his/her address book, in which case each invited user will only be put in the Inviter's address book and the group will only be created in the inviter's address book.
4. Add users to a new group. If, instead of the above option, this option is checked, then the process is similar to that described above for existing groups,
   a. The Inviter is asked to specify a group name. Say the group is named as “Bridge”.
   b. In addition, the Inviter can choose to include all the invited users in each other's address books.
   c. If the invited users do not have a group named “Bridge”, a new group will be created called “Bridge”. If they already have a group called “Bridge”, then a new group called “Bridge2” will be created. If that exists also, then “Bridge3” and so on.
   d. The Inviter can also opt to have the group only created in his/her address book, in which case each invited user will only be put in the inviter's address book and the group will only be created in the inviter's address book.

Any reordering can be done after the above process which is just a way to ease the process of adding contacts.

### Back-End Processes

The approach described above requires processing via the servers and database, which is described next. The process described below is what happens when the submit button is clicked.
1. When submit is pressed the user email IDs are validated and an error message returned if an error occurs and an option provided to allow the user to fix the incorrect email IDs.
2. The valid email IDs are checked against the database on OFI's servers.
   a. To the entered email IDs, the server sends notification of the Inviter's request to add.
   b. The email IDs that are not present on the system (i.e., not registered) are provided as a list to the Inviter and confirmation requested to send invitational requests to those.
   c. In the event that the Inviter notices an incorrect email ID, the Inviter can change that (Note that parts (a), (b), (c) can also be combined on one form).
   d. As a part of the verification, a form displays the standard letter that is to be sent out to new user's (i.e., those not yet on the system but on the Inviter's list). The Inviter can edit this letter to suit his/her purpose. The Inviter can optionally also save this edited letter for use in future invitations. The save causes the letter to be saved in a table indexed by the Inviter's account in OFI's database. The names of invited users may be entered in the form to replace the email IDs. These names are not saved as a part of the form letter but can be optionally saved in the Inviter's address book.
3. If the above is fine, the data is transmitted to OFI's servers and saved. Suppose, next, for example, without loss of any generality, that 5 email IDs are specified A,B,C,D,E by the inviter R. And suppose further that A,B,C are registered users already in the system but obviously not yet in R's address book. In which case, obviously D,E are potentially new people who will first need to register on OFI's system.
4. Option: The Inviter R has chosen to only include the others in self address book and no groups.
   a. Users A,B,C are informed via the communicator that R has asked for them to be added to R's address book. As each accepts, each user is added to R's address book and R added to the accepting user's address book. If say, C, declines, then R is blocked from C's address book. If the others are not in C's address book then they are also blocked from C's address book; that is already present users in C's address book are not blocked as is obvious. In the future C can unblock, if so desired. During this phase, the registered users will see as pending all other users on the list sent out by R. A tool tip will show who invited them; alternatively they will appear in a temporary group which has the name of the Inviter R; the group will disappear after the acceptance is resolved. The unregistered users (E and D, for example) will see a list in their email. Upon registering and accepting, the behavior will be the same as for the registered users.
   b. Emails are sent to new users, say D,E to register. Once a new user, say D, registers then D is added to R's book and R is added to D's book. If E does not register then a reminder email is sent after a fixed amount of time (days) followed by a second reminder. If E does not register within some time period, then the request is cancelled and R is informed of such. If E declines the invitation, then also the request is cancelled and no further reminders are sent to E. If E registers, then E can still decline the invitation to be a part of R's address book and other user's address book.
   c. The above cases are handled by keeping track in the database of the users invited, by the inviter R and flags to specify no group and to be included with R only. Time stamps are also kept to track when to follow up. Registered users get an entry of the invitation by R in their address book. For new users, a temporary ID is created that is made permanent when the new user registers. For existing users and inviter R, entries of invited people are made in their contact list but marked as pending.
5. Option: The Inviter R has chosen to include the others in self address book in a group, say, “Tennis.” This works the same as above, except, now the entries are made in the address book and also in the group “Tennis”. Note that, it is assumed that, any conflicts with the name “Tennis” have already resolved as specified earlier.
6. Option: The Inviter R has chosen to all in each other's address book and no group. This works similar to item 4 with the following difference:
   a. Now the database flag specifies that they will be included in each other's address book.
   b. Then as each user accepts, their address books are updated with other users who have accepted. During this phase, the registered users will see as pending all other users on the list sent out by R. A tool tip will show who invited them. The unregistered users (E and D, for example) will see a list in their email. Upon registering and accepting, the behavior will be the same as for the registered users.
   c. In the database all this is tracked through the Inviter's ID (but some other method could also be used).
7. Option: The Inviter R has chosen to add all in each other's address book and a group say “Bridge”. This is similar to item 6 with the following difference:
   a. The group is created in each registered person's address book and created in self address book if not already present. When new users D,E register, then this group is created in their address book if they accept the invitation.
   b. The flag for group is set to yes in the database and the name of the group recorded in the database.
   c. If the group is already present then the rules described above are followed for choosing alternate names.

### Processes for Establishing Initial Video for Video Conference Incoming Call

Described below are processes for showing the caller's video on each receiver's screen as soon as the caller makes the call.

### Call Includes Video

The moment a call comes in, the receiver hears a ringing and sees the video of the caller before the call has been accepted by the receiver. The receiver's video is not transmitted to the caller until the receiver accepts the call. Ringing can occur simultaneously with the caller video showing up, before the caller video shows up, after the caller video shows, or not be there at all with the video.

The caller's video appears in a display size set by the receiver. Possibilities are that the receiver may want to see it in a fixed size, or in full screen mode, or in a multiple of the caller's transmit size. Alternatively, it can default to any size controlled by the application or the caller (e.g., managed calls, as in corporate meetings).

The appearance of the caller video on the receiver's end can be in a specified size or can be animated to reach the specified size. The animation can be simple growth from small to specified size or more elaborate as necessary.

The sequence of steps as to how the above takes place is as follows:
1. For simplicity of exposition, suppose User C (Caller) makes a call to User R (Receiver); both of whom are signed into their accounts.
2. User C's computer sends information to the server to set up the call. The setup includes various network related information (such as ports) to set up the call. A window opens up on User C's screen indicating that the call is initiated and that it is waiting for a response from User R. Note that if User R was not signed in, this would not occur; instead User C would be directed to leave a message if desired.
3. The server transmits the data to User R's machine.
   a. The data includes who is calling, video of User C, Audio of User C, and other information. Video and audio are transmitted in a continuous stream per User C's settings from C to the server, which then redirects to R. In one embodiment, the audio may not be transmitted until User R responds. This can be changed through user settings. Transmission of audio is along similar lines to transmission of video.
   b. Similar to the above, if a peer-to-peer call is established, then the video and/or audio of User C is transmitted directly between C and R. Other information can still be transmitted by the server.
4. On User R's machine, the client software has already transmitted various network relate information to the server based on the server's request for such. After this, it becomes aware of the incoming video and audio and sets up to display the video of caller C.
5. Video display.
   a. The video is next sized to be displayed per the size settings that are internally stored or retrieved form User C (as in the case of managed calls).
   b. Alternatively, the sizing is animated to grow to the pre-specified display size for incoming calls. The animation can be slow or fast. During animation the window can change shape for effects.
6. User R can accept the call or decline it at this stage. Only after User R accepts will R's video and/or audio will transmit to User C. The accept/decline sequence is not relevant to this discussion.

Note: Visual Communicator may also include text chat. Even if the option is enabled, the text chat window does not open up on R's screen until R accepts the call. This is by design, but it could be done either way to open up or not open up as C calls and before R accepts. This is similar to other media transmission.

The default setting is to not enable the audio on R's machine with the incoming call which was done so that R did not get disturbed by a call. Through settings a user can enable the audio to be transmitted to him/her together with the video on an incoming call if so desired. In this case if User C starts talking, R will see and hear caller C before accepting or declining the call. (Caller C will be informed that R has allowed audio to be heard also).

### Call Does Not Include Video

This situation includes all cases where video is not available; i.e., the caller does not have a camera, has blocked his/her camera, or has disabled video from the call. The approach here is similar to that described in the previous section; except now there is no video so an image is shown. If the caller has an image specified as his/her image, then that is shown. If the caller has not specified an image; then a silhouette is shown. In the case of a silhouette, it would be prudent to ignore the settings and show it in a fixed small size. Even in the case of a fixed image, we probably want to show it in some nominal size. We should retain the option of showing it in the same manner as the live video.

A further variation of this theme is to show a pre-recorded video.

Other than the above all, the functionally is similar to that describe in the previous section. The video of the caller is not transmitted, only the image. The silhouette needs not be transferred at this stage since it can be kept at the receiver's machine. The image is also already available on the receiver's machine because it is downloaded as a part of the address book.

The present invention has been described in particular detail with respect to a limited number of embodiments. One skilled in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of the above description present the feature of the present invention in terms of algorithms and symbolic representations of operations on information. These algorithmic descriptions and representations are the means used by those skilled in the art to most effectively convey the substance of their work to others skilled in the art. These operations, while described functionally or logically, are understood to be implemented by computer programs. Furthermore, it has also proven convenient at times, to refer to these arrangements of operations as modules or code devices, without loss of generality.

It should be borne in mind, however, that all of these and similar terms are to be associated with the appropriate physical quantities and are merely convenient labels applied to these quantities. Unless specifically stated otherwise as apparent from the present discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CDs, DVDs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the present invention is not described with reference to any particular programming language. It is appreciated that a variety of programming languages may be used to implement the teachings of the present invention as described herein, and any references to specific languages are provided for disclosure of enablement and best mode of the present invention.

The figures depict preferred embodiments of the present invention for purposes of illustration only. One skilled in the art will readily recognize from the following discussion that alternative embodiments of the structures and methods illustrated herein may be employed without departing from the principles of the invention described herein.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

I claim:

1. A method for establishing initial video for a receiver of a video conference incoming call initiated by a caller, comprising:
receiving, by a computer of the receiver, from the caller data related to the video conference incoming call, the data including video of the caller;
responsive to receiving the data, playing a sound indicating the incoming call and displaying the video of the caller;
receiving a input from the receiver to accept the incoming call; and
responsive to receiving the input to accept the incoming call, transmitting video of the receiver to the caller.
